(19) United States
(12) Patent Application Publication
(10) Pub. No.: US 2025/0307032 A1
(43) Pub. Date: Oct. 2, 2025

(54) COMPUTE ISLAND ALLOCATION BASED ON POWER PRIORITIES

(71) Applicant: ADVANCED MICRO DEVICES, INC., Santa Clara, CA (US)

(72) Inventors: Srilatha Manne, Seattle, WA (US); Rajagopalan Desikan, Austin, TX (US); Francisco L. Duran, Clearwater, FL (US); Heather Lynn Hanson, Austin, TX (US); Noah B. Beck, Princeton, MA (US); Robert A. Hershberger, Austin, TX (US); Shayantika Bhattacharya, Bengaluru (IN); Shidhartha Das, Great Cambourne (GB)

(21) Appl. No.: 18/621,712

(22) Filed: Mar. 29, 2024

(51) Int. Cl. G06F 9/50; G06F 9/455

(52) U.S. Cl. CPC G06F 9/5094; G06F 9/45558; G06F 2009/45562; G06F 2009/45591; G06F 2209/501

(57) ABSTRACT

To execute applications for virtual machines (VM) on a system on a chip (SoC), the SoC includes one or more chiplets each including one or more processor cores. Additionally, these chiplets are grouped into two or more compute islands each powered by a respective power rail and each associated with a corresponding power priority. A hypervisor is configured to allocate at least a portion of a compute island to a VM based on a comparison of a performance requirement of the VM and the power priorities of the compute islands of the SoC.

### BACKGROUND

Some processing systems are configured to concurrently support multiple virtual machines (VMs) each configured to execute one or more applications. To enable the VMs to execute these applications, these processing systems include a hypervisor configured to allocate respective processor cores of a processor, such as a graphics processing unit (GPU), to the VMs. Using an allocated processor core, a VM executes instructions and operations for the applications and stores results from the execution of these instructions and operations in system memory.

Additionally, the VMs concurrently executing on these processing systems often have different performance requirements (e.g., performance settings) such as different operating frequency requirements, operating voltage requirements, and the like. To accommodate the different performance requirements of the VMs, the processor cores of the processor operate at certain frequencies or voltages that are able to accommodate the performance requirements of any of the VMs. However, having the processor cores of the processor operate at a frequency or voltage that accommodates the performance requirements of any of the VMs increases the likelihood that a VM operates at a higher frequency or voltage than is required to meet the performance requirements of the VM, increasing the power consumption and lowering the processing efficiency of the processing system.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system configured for virtual machine allocation based on power priorities of compute islands, in accordance with some embodiments.

FIG. 2 is a block diagram of an system on a chip (SoC) including compute islands each having respective power priorities, in accordance with some embodiments.

FIG. 3 is a block diagram of an example dynamic voltage and frequency scaling circuitry configured to change the operating frequency or operating voltage of compute islands based on trigger events, in accordance with some embodiments.

FIG. 4 is a flow diagram illustrating an example method for allocating virtual machines based on compute island power priorities, in accordance with some embodiments.

### DETAILED DESCRIPTION

Systems and techniques disclosed herein are directed to a processing system configured to concurrently execute multiple virtual machines (VMs). Such VMs are each configured to execute one or more applications such as graphics rendering applications, compute applications, machine-learning applications, neural network applications, databasing applications, and the like, to name a few. To enable the VMs to execute these applications, the processing system includes one or more chiplets each including one or more processor cores. Additionally, the processing system includes a hypervisor configured to allocate respective processor cores of one or more chiplets to corresponding VMs. For example, the hypervisor allocates one or more processor cores of a first chiplet to a first VM. After being allocated one or more processor cores, VM then uses the allocated processor cores to perform instructions, operations, or both for one or more applications. However, two or more VMs being concurrently executed by the processing system are likely to have different performance requirements for performing one or more applications. These performance requirements of a VM, for example, indicate the maximum operating frequency, minimum operating frequency, average operating frequency, maximum operation voltage, minimum operating voltage, average operating voltage, timings (e.g., deadlines for results, hours of operation), or any combination thereof, of a VM.

To help account for these differing performance requirements (e.g., performance settings) among the VMs, the processing system includes one or more chiplets each arranged into one or more compute islands (e.g., compute groups). These compute islands, for example, each includes one or more respective processor cores, compute units, caches, portions of memory (e.g., scratch memory, local data shares), buffers, queues, registers, or any combination thereof of the one or more chiplets that form the compute island. Further, each of these compute islands has a respective power priority (e.g., power target) representing, for example, a target operating frequency, a target operating voltage, or both for the compute island (e.g., for the processor cores or compute units of the compute island). As an example, the processing system includes a first compute island having a first power priority (e.g., high priority) associated with a first target operating frequency and a second compute island having a second power priority (e.g., low priority) associated with a second target operating frequency that is lower than the first target operating frequency. As used herein, power priorities representing higher target operating frequencies, operating voltages, or both are referred to herein as “higher power priorities” when compared to power priorities representing lower target operating frequencies, operating voltages, or both.

To define the power priority at each compute island, the processing system includes power rails each configured to provide a respective power (e.g., voltage, current) to a corresponding compute island, clock circuitries each configured to provide a clock signal at a respective frequency to a corresponding compute island, or both. That is to say, the processing system includes power rails each configured to provide a respective power to one or more chiplets forming a compute island. For example, for a first compute island having a first power priority, the AU includes a corresponding power rail that provides a first voltage to the first compute island, a corresponding clock circuitry that provides a clock signal at a first frequency to the first compute island, or both such that the first compute island operates at a first target operating frequency represented by the first power priority. Likewise, for the second compute island having the second power priority, the AU includes a corresponding power rail that provides a second voltage to the second compute island that is different from the first voltage, a corresponding clock circuitry that provides a clock signal at a second frequency to the second compute island that is different from the first frequency, or both such that the second compute island operates at a second target operating frequency represented by the second power priority that is different from the first target operating frequency. In this way, the processing system is enabled to have any number of compute islands each having a corresponding power priority. That is to say, the processing system is enabled to have any number of compute islands each operating at different target operating frequencies, target operating voltages, or both.

Based on the power priorities of the compute islands, the hypervisor of the processing system is configured to allocate portions (e.g., processor cores, compute units) of the compute islands to the VMs running on the processing system. For example, the processing system is configured to expose the power priority associated with each compute island to the hypervisor. To determine which portion of a compute island to allocate to a VM, the hypervisor first determines the power priority indicated by the performance requirements of the VM. To this end, as an example, the hypervisor determines a target operating frequency, target operating voltage, or both indicated by the performance requirements of the VM. The hypervisor then compares the determined target operating frequency, target operating voltage, or both indicated by the performance requirements of the VM to the target operating frequencies, target operating voltages, or both represented by the power priorities of the compute islands. Based on the comparison of the determined target operating frequency, target operating voltage, or both indicated by the performance requirements of the VM to the target operating frequencies, target operating voltages, or both represented by the power priorities of the compute islands, the hypervisor selects a portion (e.g., one or more processor cores, one or more compute units) of a compute island of the processing system to allocate to the VM. For example, based on the comparison, the hypervisor determines the target operating frequency, target operating voltage, or both represented by a power priority that is closest in value yet still greater than the determined target operating frequency, target operating voltage, or both indicated by the performance requirements of the VM. The hypervisor then selects one or more processor cores of the compute island having this power priority to allocate to the VM. In this way, the hypervisor is enabled to allocate processor cores from compute islands with power priorities that meet the performance requirements of the VMs. By allocating processor cores from compute islands with power priorities that meet the performance requirements of the VMs, the likelihood that the VMs are allocated to processor cores operating at a higher frequency or voltage than is necessary for their performance is reduced, helping reduce the power consumption and helping improve the processing efficiency of the processing system.

To further help reduce the power consumption and improve the processing efficiency of the processing system, the processing system includes a dynamic voltage and frequency scaling (DVFS) circuitry configured to modify the corresponding power, clock signal frequencies, or both provided to each compute island based on one or more trigger events. Such trigger events, for example, include a predetermined number of VMs being launched by the processing system, a predetermined amount of time elapsing, a power emergency (e.g., voltage spike, current spike, voltage droop, current droop) occurring, or any combination thereof. For example, in some implementations, the DVFS circuitry is configured to initially control one or more power rails, clock circuitries, or both such that each compute island receives the same voltage, a clock signal at the same frequency, or both. Based on a predetermined number of VMs being launched, the DVFS circuitry then modifies the power, clock signal frequencies, or both provided to one or more compute islands such that one or more compute island each receives a certain power (e.g., voltage, current), clock signal at a certain frequency, or both that allows the compute island to operate at the target frequency, target voltage, or both represented by the power priority (e.g., power target) of the compute island. As another example, in response to a power emergency (e.g., voltage droop) occurring, the DVFS circuitry is configured to reduce the power (e.g., voltage, current), frequency of the clock signal, or both provided to a compute island having the lowest power priority (e.g., the power priority representing the lowest target operating voltage, lowest target operating frequency, or both). In this way, the DVFS circuitry is configured to reduce the power consumption of compute islands having lower power priorities by reducing the voltage, clock frequency, or both provided to these compute islands without reducing the power consumption of the compute islands having higher power priorities. As such, the DVFS circuitry is configured to reduce the power consumption of the processing system without affecting the operation of the VMs assigned to compute islands with higher power priorities.

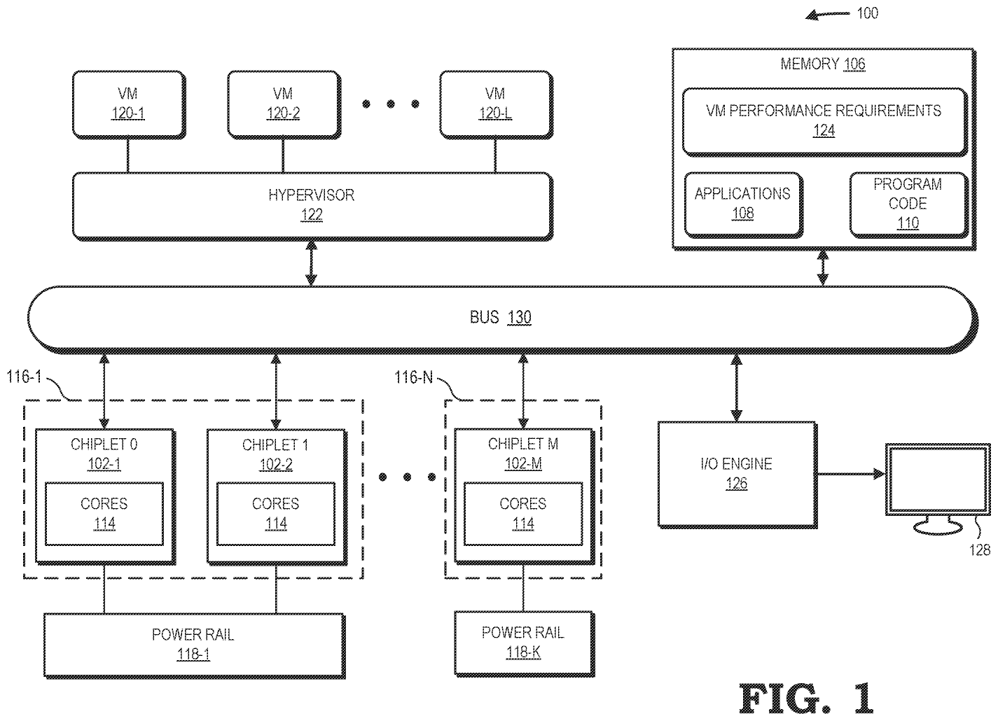

FIG. 1 is a block diagram of a processing system 100 configured for virtual machine (VM) allocation based on power priorities of compute islands (e.g., compute groups), according to some embodiments. According to embodiments, processing system 100 is implemented as a system on a chip (SoC). The processing system 100 includes or has access to system memory 106 or other storage components implemented using a non-transitory computer-readable medium, for example, a dynamic random-access memory (DRAM). However, in embodiments, system memory 106 is implemented using other types of memory including, for example, static random-access memory (SRAM), nonvolatile RAM, and the like. According to embodiments, system memory 106 includes an external memory implemented external to the processing units implemented in the processing system 100. The processing system 100 also includes a bus 130 to support communication between entities implemented in the processing system 100, such as system memory 106. Some embodiments of the processing system 100 include other buses, bridges, switches, routers, and the like, which are not shown in FIG. 1 in the interest of clarity. In embodiments, processing system 100 is configured to concurrently execute two or more VMs 120. Each VM 120, for example, is configured to execute one or more applications 108 stored in system memory 106 as, for example, program code 110. These applications 108, for example, include graphics rendering applications, compute applications, machine-learning applications, neural network applications, databasing applications, and the like. Though the example embodiment presented in FIG. 1 illustrates processing system 100 as configured to concurrently execute three VMs (120-1, 120-2, 120-L) representing an L number of VMs 120, in other embodiments, the processing system 100 can be configured to concurrently execute any number of VMS 120.

To help the VMs 120 execute one or more applications 108, processing system 100 includes one or more chiplets 102 each configured to execute instructions, operations, or both for the applications. In embodiments, the chiplets 102 of processing system 100 each function as one or more processors such as one or more vector processors, coprocessors, graphics processing units (GPUs), general-purpose GPUs (GPGPUs), non-scalar processors, central processing units (CPUs), highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs)), or any combination thereof. In some embodiments, one or more chiplets 102 are configured to operate as a type of processor (e.g., GPU, CPU) different from one or more other chiplets 102 of processing system 100. Additionally, according to some embodiments, one or more chiplets 102 are configured to operate as a same type of processor as one or more other chiplets 102 of processing system 100. As an example, in embodiments, processing system 100 includes one or more chiplets 102 each configured to function as a GPU and one or more other chiplets each configured to function as a CPU. Though the example embodiment presented in FIG. 1 shows processing system 100 as including three chiplets (102-1, 102-2, 102-M) representing an M number of chiplets, in other embodiments, processing system 100 includes any number of chiplets 102.

To execute one or more instructions, operations, or both for the applications 108 of the VMs 120, each chiplet 102 includes one or more processor cores 114 that together execute instructions concurrently or in parallel. For example, one or more processor cores 114 of a chiplet 102 execute instructions, operations, or both from an instruction pipeline (e.g., graphics pipeline, compute pipeline) to produce one or more results for one or more applications 108. In embodiments, one or more chiplets 102 include a different number of processor cores 114 than one or more other cores of processing system 100, one or more chiplets 102 include a same number of processor cores 114 as one or more other processor cores of processing system 100, or both.

According to some embodiments, one or more processor cores 114 of one or more chiplets 102 each operate as a compute unit configured to perform one or more instructions, operations, or both for one or more applications 108 of the VMs 120. As an example, one or more chiplets 102 of processing system 100 functioning as a GPU include one or more processor cores 114 each functioning as one or more compute units. Such compute units, in some embodiments, each include one or more single instruction, multiple data (SIMD) units that perform the same operation on different data sets to produce one or more results. To help facilitate the performance of operations by compute units (e.g., processor cores 114 operating as compute units), one or more chiplets 102 include one or more command processors (not shown for clarity). Such command processors, for example, include circuitry configured to execute one or more instructions from a pipeline (e.g., graphics pipeline, compute pipeline) by providing data indicating one or more operations, operands, instructions, variables, register files, or any combination thereof to one or more compute units necessary for, helpful for, or aiding in the performance of one or more operations for the instructions.

In embodiments, processing system 100 includes a hypervisor 122 configured to allocate respective portions of one or more chiplets 102 to each VM 120. As an example, based on a VM 120 launching, hypervisor 122 is configured to allocate one or more respective portion of one or more chiplets 102 to VM 120 to execute instructions and operations for one or more applications 108 of the VM 120. Such a portion of a chiplet 102 allocated to the VM 120 includes, for example, one or more processor cores 114, one or more compute units, one or more processing resources, or any combination thereof. A processing resource of a chiplet 102, for example, includes a cache, portion of a memory (e.g., scratch memory, local data shares), buffer, queue, register, or any combination thereof of the chiplet 102. After a portion of a chiplet 102 is allocated a VM 120, that portion of the chiplet 102 executes instructions, operations, or both for the applications 108 of the VM 120 and stores the results (e.g., data resulting from the execution of the instructions and operations) in a cache of the allocated portion of the chiplet 102, a memory (e.g., scratch memory, local data share) of the allocated portion of the chiplet 102, system memory 106, or any combination thereof. By allocating respective portions of the chiplets 102 to each VM 120, processing system 100 is configured to concurrently support multiple VMs 120 each executing respective applications 108. In some embodiments, hypervisor 122 is executed by a chiplet 102 functioning as a CPU of processing system 100, while in other embodiments hypervisor 122 is implemented in other hardware within or otherwise connected to processing system 100.

According to embodiments, each VM 120 of processing system 100 includes a respective set of VM performance requirements 124 (e.g., performance settings). Such VM performance requirements 124, for example, indicate the maximum operating frequency, minimum operating frequency, target operating frequency, maximum operation voltage, minimum operating voltage, target operating voltage, timings (e.g., deadlines for results, hours of operation), or any combination thereof of a VM 120, to name a few. However, in some embodiments, processing system 100 concurrently executes multiple VMs 120 each having different VM performance requirements 124 (e.g., different power settings). As an example, according to some embodiments, a first VM 120-1 includes a VM performance requirement 124 indicating a first target operating frequency and a second VM 120-2 includes a VM performance requirement 124 indicating a second target operating frequency that is different (e.g., higher) than the first target operating frequency of the first VM 120-1. To help accommodate VMs 120 having different VM performance requirements 124 concurrently running on processing system 100, processing system 100 includes one or more compute islands 116 (e.g., compute groups) each formed from one or more respective chiplets 102 (e.g., processor cores 114 of one or more chiplets 102). For example, referring to the example embodiment presented in FIG. 1, chiplet 0 102-1 and chiplet 1 102-2 together form compute island 116-1 and chiplet M forms compute island 116-N. In embodiments, one or more compute islands 116 include a different number of chiplets 102 from one or more other compute islands 116 of processing system 100, one or more compute islands include the same number of chiplets 102 as one or more other compute islands 116 of processing system 100, or both.

Because each compute island 116 is formed from one or more chiplets 102, for example, each compute island 116 includes a set of one or more processor cores 114 (e.g., the processor cores 114 of the chiplets 102 forming the compute island 116), one or more processing resources (e.g., caches, portions of a memory, buffers, queues, registers of the chiplets forming the compute island 116), or both. Though the example embodiment presented in FIG. 1 illustrates processing system 100 as including two compute islands (116-1, 116-N) representing an N number of compute islands 116, in other embodiments, processing system 100 can include any number of compute islands 116 each including any number of chiplets 102. That is to say, in other embodiments, processing system 100 includes any number of chiplets 102 organized into any number of respective compute island 116. Each compute island 116, for example, is configured to execute one or more instructions, operations, or both on behalf of one or more VMs 120. As an example, one or more processor cores 114 of a compute island 116 are configured to perform one or more operations for an application 108 executed by a VM 120 and store the results (e.g., data resulting from the performance of the operation) in a cache of the compute island 116, a memory (e.g., scratch memory, local data share) of the compute island 116, the system memory 106, or any combination thereof.

In embodiments, each compute island 116 has a corresponding power priority (e.g., power target). Each power priority, for example, represents a target operating frequency, operating voltage, or both for a corresponding compute island 116 (e.g., for the processor cores 114 of the compute island 116). Further, as used herein, power priorities representing higher target operating frequencies, operating voltages, or both are referred to as “higher” power priorities when compared to power priorities representing lower target operating frequencies, operating voltages, or both (e.g., “lower” power priorities). To enable each compute island 116 to have a corresponding power priority, processing system 100 includes a respective power rail 118 for each compute island 116. Each power rail 118, for example, includes circuitry configured to provide a voltage, current, or both to a corresponding compute island 116. That is to say, each power rail 118 includes circuitry configured to provide a voltage, current, or both to each chiplet 102 forming the compute island 116. As an example, in the embodiment presented in FIG. 1, a first power rail 118-1 provides a first voltage to a first compute island 116-1 and a second power rail 118-K provides a second voltage to a second compute island 116-N with the first voltage being different from the second voltage. Though the example embodiment presented in FIG. 1 shows processing system 100 as including two power rails (118-1, 118-k) each configured to power a corresponding compute island 116 (e.g., the chiplets 102 of the compute island 116), in other embodiments, processing system 100 includes any number of power rails 118 each configured to power a corresponding compute island 116.

Because each compute island 116 is powered by a corresponding power rail 118, each compute island 116 is enabled to receive a different voltage, current, or both and operate at different target operating frequencies, target operating voltages, or both from one or more other compute islands 116. That is to say, because each compute island 116 is powered by a corresponding power rail 118, each compute island 116 is enabled to receive a certain voltage, current, or both that allows the compute island 116 to operate at the target operating frequency, target operating voltage, or both indicated by the power priority (e.g., power target) of the compute island. In some embodiments, to enable each compute island 116 to have a corresponding power priority, processing system 100 includes a corresponding clock circuitry (not shown for clarity) for each compute island 116. Each clock circuitry, for example, is configured to provide a clock signal at a respective frequency to a corresponding compute island 116. Due to processing system including a clock circuitry for each compute island 116, each compute island 116 is enabled to receive a clock signal with a certain frequency that allows the compute island 116 to operate at the target operating frequency, target operating voltage, or both indicated by the power priority of the compute island 116. According to some embodiments, processing system 100 includes both a respective power rail 118 and clock circuitry for each compute island 116 while in other embodiments, processing system 100 includes a power rail 118 or clock circuitry for each compute island 116.

According to embodiments, processing system 100 is configured to expose the compute islands 116 (e.g., compute groups) and corresponding power priorities of the compute islands 116 to the hypervisor 122. That is to say, processing system 100 allows the hypervisor 122 to access data indicating each compute island 116 of processing system 100 and the corresponding power priority of each compute island 116. The hypervisor 122 is then configured to allocate portions (e.g., processor cores 114, processing resources) of the compute islands 116 to each VM 120 based on the power priorities of the compute islands 116 and the VM performance requirements 124 (e.g., performance settings) of the VMs. For example, to allocate one or more processor cores 114 of a compute island 116 to a VM 120, the hypervisor 122 first determines one or more VM performance requirements 124 of the VM 120. The hypervisor 122 then compares the determined VM performance requirements 124 of the VM 120 to the power priorities of the compute islands 116 to identify a power priority (e.g., power target) that meets the determined VM performance requirements 124. After identifying the power priority that meets the determined VM performance requirements 124, the hypervisor 122 allocates one or more processor cores 114, compute units, processing resources, or any combination thereof of the compute island 116 having the identified power priority to the VM 120 by, for example, updating one or more registers of processing system 100. In this way, the hypervisor 122 is configured to allocate, to the VMs, processor cores 114 of compute islands 116 having power priorities that meet the various VM performance requirements 124 of the VMs 120. Because each compute unit of a compute island 116 is allocated to a VM 120 so as to meet the certain VM performance requirements 124 of the VM 120, the likelihood that that VMs 120 are allocated compute islands 116 operating at a higher frequency or voltage than is needed for their performance is reduced, helping reduce the power consumption and improve the processing efficiency of processing system 100.

As an example, to allocate a compute unit of a compute island 116 to a VM 120, the hypervisor 122 first determines a target operating frequency of a VM 120. The hypervisor then compares the determined target operating frequency of the VM 120 to the target operating frequencies, target operating voltages, or both represented by the power priorities of the compute islands 116 to identify which power priority meets the determined target operating frequency of the VM 120. For example, the hypervisor 122 identifies the power priority representing a target operating frequency that is closest in value but still greater than the determined target operating frequency of the VM 120 as the power priority that meets the determined target operating frequency of the VM 120. As another example, the hypervisor 122 determines a timing of a VM 120 indicating that results of an application 108 are urgent (e.g., to be determined as quickly as possible). Based on the hypervisor 122 determining a timing of a VM 120 indicating that results of an application 108 are urgent, the hypervisor 122 compares the power priorities of the compute islands 116 to determine the highest power priority (e.g., the power priority representing the highest target operating frequency or voltage). The hypervisor 122 then allocates one or more processor cores 114 of the compute island 116 having the highest power priority to the VM 120.

According to some embodiments, the hypervisor 122 is configured to allocate one or more processor cores 114 of a first compute island 116 having a first power priority to a VM 120 at a first time and one or more processor cores 114 of a second compute island 116 having a second power priority to the VM 120 at a second time based on the VM performance requirements 124 of the VM 120. For example, in some embodiments, the hypervisor 122 determines a timing of a VM 120 indicating that the VM 120 performs urgent operations during a first time period and performs background operations during a second time period. Based on the hypervisor 122 determining a timing of a VM 120 indicating that the VM 120 performs urgent operations during a first time period and performs background operations during a second time period, the hypervisor 122 compares the determined VM performance requirements 124 of the VM 120 to the power priorities of the compute islands 116 to determine a first power priority that meets the VM performance requirements 124 of the VM 120 during the first time period (e.g., when the VM is performing urgent operations). The hypervisor 122 then allocates one or more processor cores 114 of a first compute island 116 having the first power priority to the VM 120 during the first time period. Further, the hypervisor allocates one or more processor cores 114 of a second compute island 116 having a second power priority, lower than the first power priority, to the VM 120 during the second time period (e.g., when the VM 120 is performing background operations). In this way, the hypervisor 122 is configured to allocate processor cores 114 from compute islands 116 with power priorities that meet the VM performance requirements 124 of a VM even when those VM performance requirements 124 change over time.

Additionally, in embodiments, processing system 100 is configured to control the power provided to each compute island 116, the frequency of the clock signal provided to each compute island 116, or both based on one or more trigger events. For example, in some embodiments, processing system 100 includes a dynamic voltage and frequency scaling (DVFS) circuitry configured to control the power rails 118, clock circuitries, or both of the compute islands 116 so as to modify the power (e.g., voltage, current) provided to one or more compute islands 116, the frequencies of the clock signals provided to one or more compute islands 116, or both based on one or more trigger events occurring. These trigger events, for example, include a predetermined number of VMs 120 being launched by processing system 100, a predetermined amount of time elapsing, a power emergency (e.g., voltage spike, current spike, voltage droop, current droop) occurring, or any combination thereof. As an example, according to some embodiments, the DVFS circuitry of processing system 100 is configured to first modify the power provided by the power rails 118 to each compute island 116, the frequencies of the clock signals provided to each compute island 116, or both such that the processor cores 114 of each compute island 116 operate at the same operating frequency, operating voltage, or both.

As an example, the DVFS circuitry of processing system 100 first modifies the power provided by the power rails 118 to each compute island 116, the frequencies of the clock signals provided to each compute island 116, or both such that the processor cores 114 of each compute island 116 operate at the target operating frequency, target voltage, or both represented by the highest power priority (e.g., highest power target) of the compute islands 116. Based on a predetermined number of VMs 120 being launched on processing system 100, the DVFS circuitry of processing system 100 then modifies the power provided by the power rails 118 to one or more compute islands 116, the frequencies of one or more clock signals provided to one or more compute islands 116, or both such that the processor cores 114 of one or more compute islands 116 each operate at the target operating frequency, target voltage, or both represented by the respective power priority (e.g., power target) of their compute island 116. As another example, based on a power emergency (e.g., voltage spike, current spike, voltage droop, current droop) occurring, the DVFS circuitry of processing system 100 modifies the power provided by the power rails 118 to one or more compute islands 116 having the lowest power priorities, the frequencies of one or more clock signals provided to one or more compute islands 116 having the lowest power priorities, or both so as to reduce the operating frequency, operating voltage, or both of the processor cores 114 of these compute islands 116 having the lowest power priorities. In this way, processing system 100 is configured to reduce the power consumed by the processor cores 114 of the compute islands 116 having lower power priorities without affecting the performance of the processor cores 114 of compute islands 116 having higher power priorities.

In some embodiments, processing system 100 includes input/output (I/O) engine 126 that includes circuitry to handle input or output operations associated with display 128, as well as other elements of the processing system 100 such as keyboards, mice, printers, external disks, and the like. The I/O engine 126 is coupled to the bus 130 so that the I/O engine 126 communicates with the system memory 106 and one or more chiplets 102.

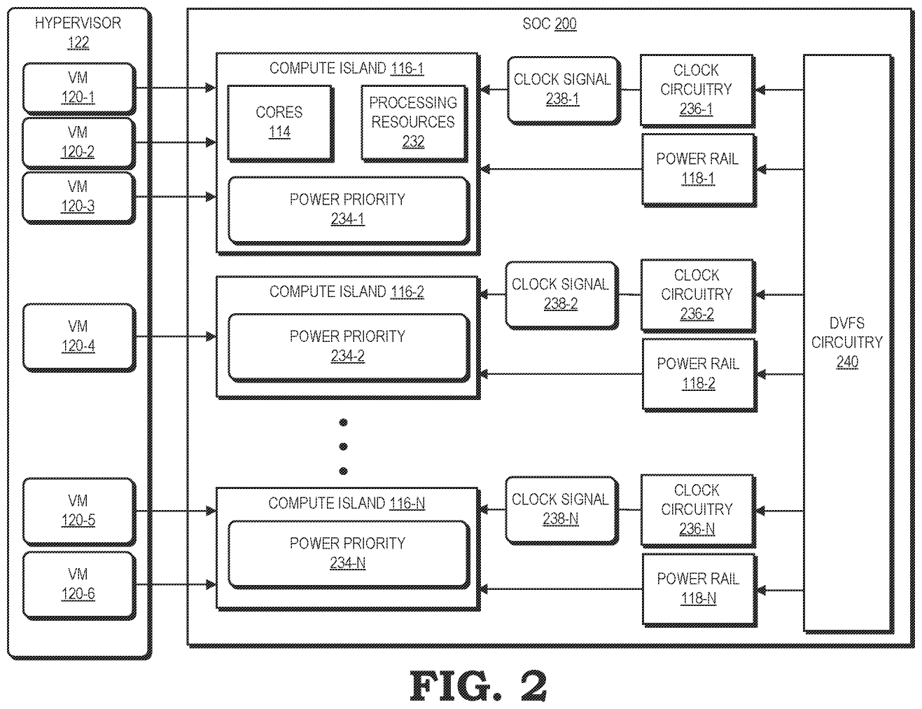

Referring now to FIG. 2, an example SoC 200 including compute islands each having respective power priorities is presented, in accordance with some embodiments. According to embodiments, processing system 100 is implemented as example SoC 200. In embodiments, example SoC 200 includes multiple compute islands 116 (e.g., compute groups) each including a respective set of processor cores 114 and one or more processing resources 232 from one or more respective chiplets 102 (e.g., the chiplets 102 forming the compute island 116). Processing resources 232 include, for example, one or more caches, portions of a memory (e.g., scratch memory, local data shares), buffers, queues, registers, or any combination thereof of one or more chiplets 102 forming a compute island 116. Though the example embodiments presented in FIG. 2 shows example SoC 200 as including three compute islands 116 representing an N number of compute islands, in other embodiments, example SoC 200 can have any number of compute islands 116.

To help execute instructions, operations, or both for VMs 120 with different VM performance requirements 124 (e.g., different performance settings), in embodiments, each compute island 116 of example SoC 200 has a corresponding power priority (234-1, 234-2, 234-N). A power priority 234, also referred to herein as a “power target,” for example, represents a target operating frequency, target operating voltage, or both for the processor cores 114 of a corresponding compute island 116. In embodiments, higher power priorities 234 represent greater target operating frequencies, target operating voltages, or both when compared to other power priorities 234, and lower power priorities 234 represent lower target operating frequencies, target operating voltages, or both when compared to other power priorities 234. In some embodiments, two or more compute islands 116 have different power priorities 234 while in other embodiments, two or more compute islands 116 have the same power priority 234. According to embodiments, to enable the processor cores 114 of each compute island 116 to operate at a target operating frequency, target operating voltage, or both indicated by a corresponding power priority 234, example SoC 200 includes a respective power rail 118, respective clock circuitry 236, or both for each compute island 116. Each power rail (118-1, 118-2, 118-N), for example, is configured to provide a certain voltage, current, or both to a corresponding compute island 116 so as to have the processor cores 114 of the compute island 116 operate at the target operating frequency, target operating voltage, or both indicated by the power priority 234 of the compute island 116. Further, each clock circuitry (236-1, 236-2, 236-N) is configured to provide a respective clock signal (238-1, 238-2, 238-N) at a certain frequency so as to have the processor cores 114 of the compute island 116 operate at the target operating frequency, target operating voltage, or both indicated by the power priority 234 of the compute island 116.

In embodiments, example SoC 200 is configured to expose the compute islands 116 and their corresponding power priorities 234 to the hypervisor 122. Based on the power priorities 234 of the compute islands 116, the hypervisor 122 is configured to allocate portions (e.g., one or more processor cores 114, one or more processing resources 232) of the compute islands 116 to each VM 120 running on processing system 100. For example, to allocate one or more processor cores 114, one or more processing resources 232, or both of a compute island 116 to a VM 120, the hypervisor 122 first determines one or more VM performance requirements 124 of the VM such as the target operating frequency, and timings (e.g., deadlines for results, hours of operation) of the VM 120. After determining the VM performance requirements 124 of the VM 120, the hypervisor 122 then selects a compute island 116 from which to allocate one or more processor cores 114, processing resources 232, or both to the VM 120 based on the power priorities 234 of the compute islands 116. To this end, for example, the hypervisor 122 compares the determined VM performance requirements 124 of the VM 120 to the target operating frequencies, target operating voltages, or both represented by the power priorities 234 of the compute islands 116 to select the power priority 234 (e.g., power target) that meets the determined VM performance requirements 124. After selecting a power priority 234, the hypervisor 122 allocates one or more processor cores 114, processing resources 232, or both from a compute island 116 having the selected power priority 234 to the VM 120. As an example, based on the VM performance requirements 124 indicating a target operating frequency for a VM 120, the hypervisor 122 compares this target operating frequency for the VM 120 to the target operating frequencies represented by the power priorities 234. The hypervisor 122 then selects the power priority 234 representing a target operating frequency that is closest in value to yet still greater than the target operating frequency for the VM 120 and allocates one or more processor cores 114, one or more processing resources 232, or both from a compute island 116 with the selected power priority 234 to the VM 120. As another example, based on VM performance requirements 124 indicating that the deadline for results is not urgent (e.g., there is no deadline for the results, the results are for background operations), the hypervisor 122 selects the lowest power priority 234 (e.g., the power priority 234 representing the lowest target operating frequency, lowest target operating voltage, or both). The hypervisor 122 then allocates one or more processor cores 114, one or more processing resources 232, or both of a compute island 116 having the lowest power priority 234 to the VM 120.

Referring to the example embodiment presented in FIG. 2, based on the power priorities 234 of the compute islands 116 and the VM performance requirements 124 of the VMs 120, the hypervisor 122 is configured to allocate one or more processor cores 114, one or more processing resources 232, or both from compute island 116-1 to VMs 120-1, 120-2, 120-3; one or more processor cores 114, one or more processing resources 232, or both from compute island 116-2 to VM 120-4; and one or more processor cores 114, one or more processing resources 232, or both from compute island 116-N to VMs 120-5, 120-6. Though the example embodiment presented in FIG. 2 illustrates processor cores 114 and processing resources 232 from compute island 116-1 being allocated to three VMs (120-1, 120-2, 120-3), processor cores 114 and processing resources 232 of compute island 116-2 being allocated to one VM 120-4, and processor cores 114 and processing resources 232 of compute island 116-N being allocated to two VMs (120-5, 120-6), in other embodiments, any number of processor cores 114 and processing resources 232 from each compute island 116 can be allocated to any number of VMs 120.

In some embodiments, example SoC 200 is configured to change the power priorities 234 of one or more compute islands 116 based on a predetermined amount of time elapsing. For example, based on a predetermined amount of time elapsing, example SoC 200 changes a first compute island 116 from a highest power priority 234 to a lowest power priority 234 (e.g., the first compute island 116 is changed from the highest power priority 234 to the lowest power priority 234), a second compute island 116 from the lowest power priority 234 to the highest power priority, a third compute island 116 from a second highest power priority 234 to a second lowest power priority 234, a fourth compute island 116 from the second lowest power priority 234 to the second highest power priority 234, and the like. In this way, example SoC 200 is configured to distribute the wear on the compute islands 116 that comes from operating according to higher power priorities 234 (e.g., at higher target operating frequencies or voltages). Because example SoC 200 distributes the wear on the compute islands 116 in this manner, the likelihood of the compute islands 116 failing is reduced, helping to improve the reliability of example SoC 200.

According to some embodiments, example SoC 200 includes DVFS circuitry 240. DVFS circuitry 240, for example, is configured to control the power provided to each compute island 116, the frequency of the clock signal 238 provided to each compute island 116, or both based on one or more trigger events. To this end, DVFS circuitry 240 is configured to control the power rails 118, clock circuitries 236, or both corresponding to the compute islands 116 so as to modify the power (e.g., voltage, current) provided to one or more compute islands 116, the frequencies of the clock signals 238 provided to one or more compute islands 116, or both based on one or more trigger events (e.g., a predetermined number of VMs 120 being launched, a predetermined amount of time elapsing, a power emergency) occurring.

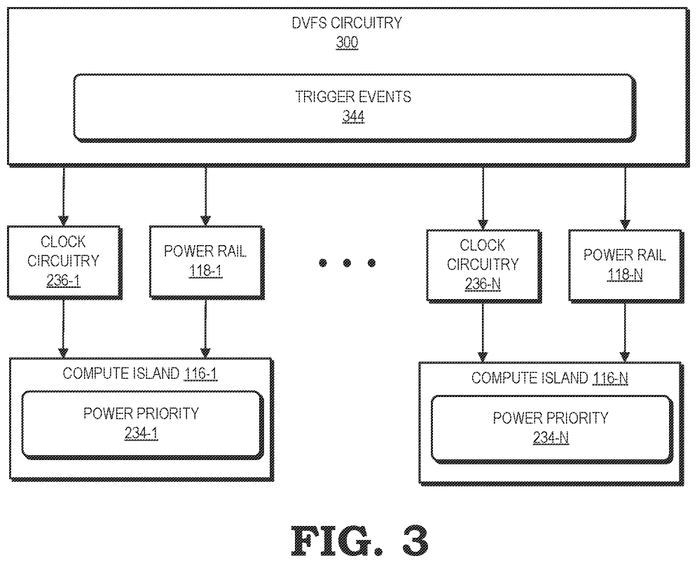

For example, referring now to FIG. 3, an example DVFS circuitry 300 is presented, in accordance with some embodiments. In some embodiments, example DVFS circuitry 300 is implemented in example SoC 200 as DVFS circuitry 240. According to embodiments, example DVFS circuitry 300 is configured to modify the power (e.g., voltage, current) provided to one or more corresponding compute islands 116, the frequencies of clock signals 238 provided to one or more corresponding compute islands 116, or both based on one or more trigger events 344. These trigger events 344, for example, include one or more predetermined events indicating that the power, frequency of the clock signal, or both provided to a compute island 116 are to be modified. For example, trigger events 344 include a predetermined number of VMs 120 being launched by processing system 100, a predetermined amount of time elapsing, a power emergency (e.g., voltage spike, current spike, voltage droop, current droop) occurring within processing system 100, or any combination thereof. According to embodiments, in response to a trigger event occurring, example DVFS circuitry 300 sends one or more signals to one or more power rails 118, clock circuitries 236, or both so as to modify the power provided by one or more power rails 118 to corresponding compute islands 116, modify the frequency of one or more clock signals 238 provided by one or more clock circuitries 236 to corresponding compute islands 116, or both.

As an example, in some embodiments, example DVFS circuitry 300 initially modifies the power provided by the power rails 118 to two or more compute islands 116, the frequencies of the clock signals 238 provided by clock circuitries 236 to two or more compute islands 116, or both such that two or more compute islands 116 (e.g., the processor cores 114 of two or more compute islands 116) operate at the target operating frequency, target voltage, or both represented by the highest power priority of the compute islands 116. That is to say, when example SoC 200 is first initialized, example DVFS circuitry 300 modifies the power provided to two or more compute islands 116, the frequencies of the clock signals 238 provided to two or more compute islands 116, or both such two or more compute islands 116 each operate at the same target operating frequency, target operating voltage, or both. After modifying the power provided to two or more compute islands 116, the frequencies of the clock signals 238 provided to two or more compute islands 116, or both such two or more compute islands 116 each operate at the same target operating frequency, target operating voltage, or both, example DVFS circuitry 300 then determines whether a trigger event 344 has occurred. As an example, example DVFS circuitry 300 determines whether a predetermined number of VMs 120 have been launched. Based on a predetermined number of VMs 120 having been launched, example DVFS circuitry 300 then modifies the power provided by the power rails 118 to one or more compute islands 116, the frequencies of one or more clock signals 238 provided by one or more clock circuitries 236 to one or more compute islands 116, or both such that one or more compute islands 116 each operate at the target operating frequency, target voltage, or both represented by the respective power priority 234 of the compute island 116. In this way, example DVFS circuitry 300 is configured to allow two or more compute islands 116 (e.g., each compute island 116) to operate at the target frequency or target voltage of the highest power priority 234 until the predetermined number of VMs 120 has been launched (e.g., a trigger event 344 occurs). After the predetermined number of VMs 120 has been launched, example DVFS circuitry 300 then reduces the target operating frequency or target operating voltage of one or more compute islands 116 based on their power priorities 234 so as to reduce the power consumption of these compute islands 116 while still maintaining the operating frequencies and operating voltages of the compute islands 116 with the highest power priorities 234.

As another example, in some embodiments, example DVFS circuitry 300 is configured to determine whether a power emergency (e.g., voltage spike, current spike, voltage droop, current droop) has occurred. Based on such a power emergency (e.g., trigger event 344) occurring, example DVFS circuitry 300 then modifies the power provided by the power rails 118 to one or more compute islands 116 having the lowest power priorities 234, the frequencies of one or more clock signals 238 provided by one or more clock circuitries 236 to one or more compute islands 116 having the lowest power priorities 234, or both so as to reduce the target operating frequency, target operating voltage, or both of these compute islands 116 having the lowest power priorities 234. In this way, example DVFS circuitry 300 is configured to help mitigate the detected power emergency by reducing the power consumption of compute islands 116 with the lowest power priorities 234 without affecting the performance of the compute islands 116 with the highest power priorities 234.

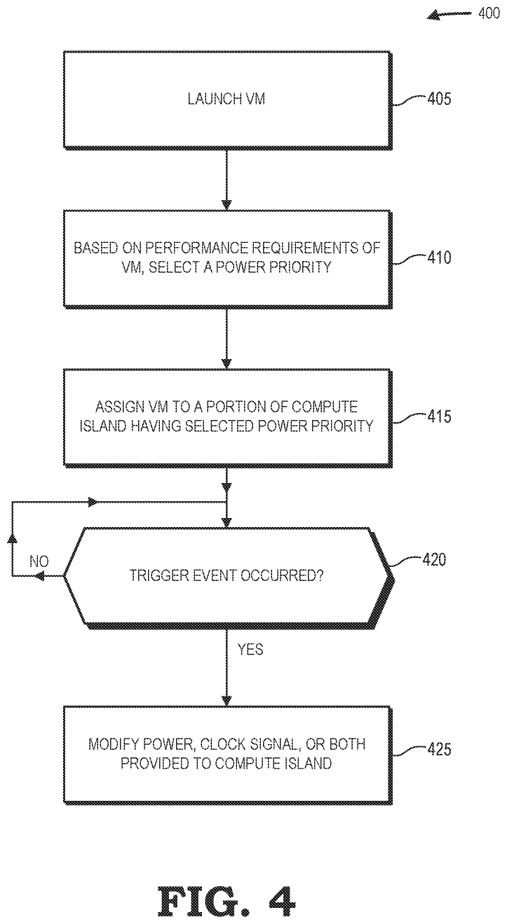

Referring now to FIG. 4, an example method 400 for allocating virtual machines based on compute island power priorities is presented, in accordance with some embodiments. In embodiments, example method 400 is implemented in processing system 100 by hypervisor 122. According to embodiments, example method 400 includes a VM 120 launching at block 405. For example, at block 405, processing system 100 is configured to begin executing the VM 120. After the VM 120 has launched, at block 410, hypervisor 122 is configured to select a power priority 234 of a compute island 116 of processor cores 114 (e.g., example SoC 200) based on one or more VM performance requirements 124 (e.g., maximum operating frequency, minimum operating frequency, target operating frequency, maximum operation voltage, minimum operating voltage, target operating voltage, timings) of the VM 120. To this end, the hypervisor 122 compares the VM performance requirements 124 (e.g., performance setting) of the VM 120 to the target operating frequencies, target operating voltages, or both represented by the power priorities 234 of the compute islands 116 so as to select a power priority 234 that satisfies the VM performance requirements 124 of the VM 120. As an example, based on determining a target operating frequency of the VM 120, the hypervisor compares the target operating frequency of the VM 120 to the target operating frequencies represented by the power priorities 234 of the compute islands 116. The hypervisor 122 then selects the power priority 234 representing a target operating frequency that is closest to but still greater than the target operating frequency of the VM 120. As another example, based on determining that the VM 120 has an urgent deadline for results (e.g., the results of the VM 120 are urgent), the hypervisor 122 selects the highest power priority 234. As yet another example, based on determining that the VM 120 has a non-urgent deadline for results (e.g., the results of the VM 120 are not urgent, the VM 120 performs background operations), the hypervisor 122 selects the lowest power priority 234. At block 415, after the hypervisor 122 has selected a power priority 234 for the VM 120, the hypervisor 122 allocates one or more processor cores 114, one or more processing resources 232, or both from a compute island 116 having the selected power priority 234 to the VM 120. For example, the hypervisor 122 updates one or more registers of the example SoC 200 so as to allocate one or more processor cores 114, one or more processing resources 232, or both from a compute island 116 having the selected power priority 234 to the VM 120.

According to some embodiments, example method 400 further includes processing system 100 (e.g., DVFS circuitry 300) modifying the target operating frequencies, target operating voltages, or both one or more compute islands 116 so as to reduce power consumption. To this end, in embodiments, at block 420, DVFS circuitry 300 is configured to determine whether a trigger event 344 (e.g., a predetermined number of VMs 120 being launched, a predetermined amount of time elapsing, a power emergency) has occurred. Based on DVFS circuitry 300 determining that no trigger event 344 has occurred, DVFS circuitry 300 repeats block 420 and continues to determine whether a trigger event 344 has occurred. Further, based on DVFS circuitry 300 determining that a trigger event 344 has occurred, DVFS circuitry 300 moves to block 425. At block 425, DVFS circuitry 300 is configured to modify the power (e.g., voltage current) provided to one or more compute islands 116, the frequency of one or more clock signals 238 provided to one or more compute islands 116, or both. For example, based on determining that a predetermined number of VMs 120 has been launched at block 420, DVFS circuitry 300 is configured to modify the power (e.g., voltage current) provided to one or more compute islands 116, the frequency of one or more clock signals 238 provided to one or more compute islands 116, or both such that the compute islands 116 operate at the target operating frequency, target operating voltage, or both of their corresponding power priorities 234. As another example, based on determining a power emergency has occurred at block 420, DVFS circuitry 300 is configured to modify the power (e.g., voltage current) provided to one or more compute islands 116, the frequency of one or more clock signals 238 provided to one or more compute islands 116, or both so as to reduce the target operating frequency, target operating voltage, or both of one or more of the compute islands 116 with the lowest power priorities 234.

In some embodiments, the apparatus and techniques described above are implemented in a system including one or more integrated circuit (IC) devices (also referred to as integrated circuit packages or microchips), such as the AU described above with reference to FIGS. 1-4. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer-readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A processing system, comprising:
a first compute group having a first power target;
a second compute group having a second power target; and
a hypervisor configured to allocate at least a portion of the first compute group or at least a portion of the second compute group to a virtual machine based on whether a performance setting of the virtual machine indicates the first power target or the second power target.

2. The processing system of claim 1, wherein the processing system further comprises:
a first power rail configured to provide a first voltage to the first compute group; and
a second power rail configured to provide a second voltage to the second compute group, wherein the first voltage is different from the second voltage.

3. The processing system of claim 2, further comprising:
a dynamic voltage and frequency scaling circuitry configured to:
modify the first voltage based on a trigger event.

4. The processing system of claim 3, wherein the trigger event includes at least one selected from a group consisting of a predetermined number of VMs being launched, a predetermined amount of time elapsing, or a power emergency occurring.

5. The processing system of claim 1, wherein the processing system further comprises:
a first clock circuitry configured to provide a first clock signal to the first compute group; and
a second clock circuitry configured to provide a second clock signal to the second compute group, wherein the first clock signal is different from the second clock signal.

6. The processing system of claim 1, wherein:
the first power target is associated with a first voltage and the second power target is associated with a second voltage that is different from the first voltage.

7. The processing system of claim 1, wherein the first compute group includes a first set of processor cores of one or more chiplets and the second compute group includes a second set of processor cores of one or more other chiplets, and wherein the first set of processor cores is different from the second set of processor cores.

8. A method, comprising:
allocating at least a portion of a first compute group or at least a portion of a second compute group to a virtual machine based on whether a performance setting of the virtual machine indicates a first power target or a second power target,
wherein the first compute group has the first power target and the second compute group has the second power target.

9. The method of claim 8, further comprising:
providing, by a first power rail, a first voltage to the first compute group; and
providing, by a second power rail, a second voltage to the second compute group, wherein the first voltage is different from the second voltage.

10. The method of claim 8, further comprising:
providing, by a first clock circuitry, a first clock signal to the first compute group; and
providing, by a second clock circuitry, a second clock signal to the second compute group, wherein the first clock signal is different from the second clock signal.

11. The method of claim 10, further comprising:
modifying the first clock signal based on a trigger event.

12. The method of claim 11, wherein the trigger event includes at least one selected from a group consisting of a predetermined number of VMs being launched, a predetermined amount of time elapsing, or a power emergency occurring.

13. The method of claim 8, wherein:
the first power target is associated with a first operating frequency and the second power target is associated with a second operating frequency that is different from the first operating frequency.

14. The method of claim 8, wherein the first compute group includes a first set of processor cores and the second compute group includes a second set of processor cores, and wherein the first set of processor cores is different from the second set of processor cores.

15. A system on a chip, comprising:
a first set of processor cores assigned a first power target;
a second set of processor cores assigned a second power target; and
a dynamic voltage and frequency scaling circuitry configured to change the second set of processor cores from an operating frequency associated with the first power target to an operating frequency associated with the second power target based on a trigger event.

16. The system on a chip of claim 15, further comprising:
a first power rail configured to provide a first voltage to the first set of processor cores; and
a second power rail configured to provide a second voltage to the second set of processor cores, wherein the first voltage is different from the second voltage.

17. The system on a chip of claim 16, wherein the dynamic voltage and frequency scaling circuitry is configured to:
modify the second voltage based on the trigger event such that the second set of processor cores is changed from the operating frequency associated with the first power target to the operating frequency associated with the second power target.

18. The system on a chip of claim 15, further comprising:
a first clock circuitry configured to provide a first clock signal to the first set of processor cores; and
a second clock circuitry configured to provide a second clock signal to the second set of processor cores, wherein the first clock signal is different from the second clock signal.

19. The system on a chip of claim 18, wherein the dynamic voltage and frequency scaling circuitry is configured to:
modify the second clock signal based on the trigger event such that the second set of processor cores is changed from the operating frequency associated with the first power target to the operating frequency associated with the second power target.

20. The system on a chip of claim 15, wherein the trigger event includes at least one selected from a group consisting of a predetermined number of VMs being launched, a predetermined amount of time elapsing, or a power emergency occurring.
